(19) United States
(12) Patent Application Publication
(10) Pub. No.: US 2003/0072451 A1
(43) Pub. Date: Apr. 17, 2003

(54) Method and apparatus for securely transferring wireless data

(76) Inventors: Roberto J. Pimentel, Laval (CA); Charles S. Assaf, Outremont (CA); Thomas V. Fischer, Yerres (FR); Farrokh K. Abadi, Montreal (CA)

Correspondence Address: ROSENTHAL & OSHA L.L.P., 1221 MCKINNEY AVENUE, SUITE 2800, HOUSTON, TX, 77010, US

(21) Appl. No.: 09/981,470

(22) Filed: Oct. 16, 2001

(51) Int. Cl. H04K 1/00

(52) U.S. Cl. 380/270

(57) ABSTRACT

A system for secure transfer of wireless data. The system includes a wireless client, an enterprise server, a server stack, a client stack, a server-side application adapter, a client-side application adapter, a volatile memory and an authentication manager. The server stack provides communication services between the enterprise server and the wireless client. The client stack provides communication services between the enterprise server and the wireless client. The server-side application adapter provides an interface between the server stack and a server application. The client-side application adapter provides an interface between the client stack and a client application. The volatile memory is located on the wireless client and stores authentication information. The authentication manager module manages authentication information stored in the volatile memory and transfers authentication information to the client-side adapter.

### BACKGROUND OF INVENTION

Mobile professionals, e.g., professionals that travel on business, require a convenient means to access information while away from the office. The information that typically has the greatest demand is contained in applications that handle e-mail, scheduling, etc. To meet this demand, mobile professionals are increasingly using wireless devices, e.g., Personal Digital Assistants (PDA) with wireless capabilities, web-enabled cellular phones, etc., to provide the link between themselves and the applications located in the office.

Wireless devices typically employ either a “pull” framework or “push” framework to connect to the office. Both technologies are based on a client/server model, where the client is a wireless device and the server is a computer located at the office, which is connected to the Internet or other Wide Area Network (WAN). Typically, one computer in the model is a wireless application server, e.g., a server that controls data transfer to and from a wireless device.

FIG. 1, illustrates a typical layout of a client/server model employing a “pull” framework. When employing a “pull” framework a client (20) sends a request (26) for information to a server (22). For example, the client (20) may request a web page by sending a Universal Resource Locator (URL) to the server (22). The server (22) responds to the request by sending the web page (24), corresponding to the URL, back to the client (20). In this model, the client (20) is said to “pull” information from the server (22).

FIG. 2, illustrates a typical layout of a client/server model employing a “push” framework. In contrast to the “pull” framework, when employing a “push” framework the client (20) does not explicitly request information from the server (22). Rather, the server (22) sends information (28) to the client (20) based on events triggered within the server (22), e.g., a new e-mail message, a change in the calendar, etc. In this model, the server (22) is said to “push” information on to the client (20).

Wireless devices send and receive data based on a wireless protocol, such as Wireless Application Protocol (WAP). WAP is a protocol that defines an industry-wide specification for developing applications that operate over wireless communication networks. The following discussion of WAP is based on the WAP protocol specification. Implementations using WAP may not be 100% WAP compliant or rely solely on the functionality provided by WAP.

With an increasing preference for a “push” framework, WAP has created a model to facilitate the use of the “push” framework. FIG. 3 illustrates a typical layout of a client/server model employing a “push” framework as specified by WAP. In a WAP “push” framework, a push operation is initiated by a server (22) transmitting push content and delivery instructions to a Push Proxy Gateway (PPG) (30). The PPG (30) then delivers the push content to a client (20) according to the delivery instructions.

The PPG (30) is responsible for delivering the push content to the client (20). In some cases, the PPG (30) is required to translate client addresses provided by the server (22) into a format understood by the wireless network, transform the push content to adapt it to the client's (20) capabilities, store content if the client (20) is unavailable, etc. In addition, the PPG (30) may also notify the server (22) about a final outcome of the pushed content, optionally handle cancellation, replacement, or client capability requests from the server (22). Further, the PPG (30) is responsible for authentication and access control policies, e.g., who is allowed to access the server (22).

The server (22) communicates with the PPG (30) using Push Access Protocol (PAP). PAP is used to carry control information related to the push content. The control information is expressed using Extensible Mark-up Language (XML).

The PPG (30) communicates with the client (20) using Push Over-The-Air Protocol (OTA). OTA is designed to run on top of HyperText Transfer Protocol (HTTP) or Wireless Session Protocol (WSP). When running OTA on top of HTTP (OTA-HTTP), the push content is delivered using an HTTP POST method. When running OTA on top of WSP (OTA-WSP), OTA extends WSP to address specific needs of the “push” framework.

FIG. 4 illustrates a typical implementation of a “push” framework within an enterprise system. An enterprise system typically includes an enterprise server (32) connected to various resources, such as a database (34). The enterprise server (32) is also connected to an internal corporate network (36), including desktop computers, networked printers, etc. The enterprise server (32) provides access to the Internet (44) for all resources operatively connected to it. To provide wireless services, the enterprise system also typically includes a push proxy gateway (38), e.g., wireless application server that manages data flow to wireless clients (40) e.g., PDA's with wireless capability, via a wireless network (42). Additionally, enterprise systems typically employ a firewall (46) as a security measure.

The firewall (46) in the enterprise system protects the enterprise system from individuals outside the internal corporate network (36) from obtaining sensitive information, e.g., confidential files. However, this security measure is typically only sufficient for securing the internal corporate network (36), enterprise servers (32), wireless application servers (38), and enterprise server resources such as the database (34). Once information leaves the wireless server (38) and passes through the firewall (46), the information that is not encrypted is most likely insecure.

Corporations typically employing enterprise systems have rules regarding the type of information that may be sent outside the internal corporate network (36). According to the rules of a majority of corporations with enterprise systems, transmission of data to wireless clients (40) as part of a push request is typically not secure enough to allow the receipt of sensitive information via a wireless network (42).

Still referring to FIG. 4, WAP has developed two security models to address the security issues of using wireless devices to transfer sensitive information. The first relies on authenticating the enterprise server (32) using session level certificates, HTTP authentication, or a combination of the aforementioned technologies. The authentication of the enterprise server (32) is conducted by the PPG (38). The confidential data is then pushed to the wireless client (40). Typically, the data is transmitted in encrypted form.

The second security model involves wireless client (40) delegation of the server (32) authentication. In this model, the wireless client (40) authenticates the PPG (38), which subsequently authenticates the server (32). The wireless client (40) typically uses Wireless Transport Layer Security (WTLS) to authenticate the PPG (30). The PPG (30), in turn, uses one of the methods described in the first model to authenticate the server (32). Once the PPG (38) and the server (32) have been authenticated, the server (32) “pushes” the data to the wireless client (40). Typically, the data is transmitted in encrypted form.

### SUMMARY OF INVENTION

In general, in one aspect, the invention comprises a system for secure transfer of wireless data. The system comprises a wireless client and an enterprise server. A server stack located on the enterprise server provides communication services between the enterprise server and the wireless client. A client stack located on the wireless client provides communication services between the enterprise server and the wireless client. A server-side application adapter located on the enterprise server provides an interface between the server stack and a server application. A client-side application adapter located on the wireless client provides an interface between the client stack and a client application. A volatile memory located on the wireless client stores authentication information. An authentication manager module manages authentication information in the volatile memory and transfers authentication information to the client-side application adapter.

In general, in one aspect, the invention comprises a system for secure transfer of wireless data. The system comprises a wireless client and an enterprise server. A server stack located on the enterprise server provides communication services between the enterprise server and the wireless client. A client stack located on the wireless client provides communication services between the enterprise server and the wireless client. A server-side application adapter located on the enterprise server provides an interface between the server stack and a server application. A client-side application adapter located on the wireless client provides an interface between the client stack and a client application. A volatile memory located on the wireless client stores authentication information. An authentication manager module manages authentication information in the volatile memory and transfers authentication information to the client-side application adapter. A wireless gateway provides an interface between the enterprise server and the wireless client.

In general, in one aspect, the invention comprises an enterprise server for securely transferring wireless data. The enterprise server comprises a server stack located on the enterprise server that provides communication services between the enterprise server and a wireless client. A server-side application adapter located on the enterprise server provides an interface between the server stack and a server application.

In general, in one aspect, the invention comprises a wireless client for securely transferring wireless data. The wireless client comprises a client stack located on the wireless client that provides communication services between an enterprise server and the wireless client. A client-side application adapter located on the wireless client provides an interface between the client stack and a client application. A volatile memory stores authentication information on the wireless client. An authentication manager module manages authentication information in the volatile memory and transfers authentication information to the client-side application adapter.

In general, in one aspect, the invention comprises a method for securely transferring wireless data from an enterprise server to a wireless client. The method comprises receiving data on the enterprise server. An event is triggered on a server-side application adapter. A notification message is forwarded to a server stack. The notification message is sent from the server stack within the server to a client stack within the wireless client. The notification message is received on the client stack. The notification message is forwarded to a client-side application adapter. Authentication information is requested from an authentication manager module. Authentication information is checked for in a volatile memory within the wireless client. A request is sent from the client stack to the enterprise stack. Authentication information is authenticated on the enterprise server. A secure session is opened between the wireless client and the enterprise server. Data is transferred from the server stack to the client stack. Data is forwarded to the client-side application adapter. Data is forwarded to a client application.

In general, in one aspect, the invention comprises a method for securely transferring wireless data from an enterprise server to a wireless client. The method comprises receiving data on the enterprise server. An event is triggered on a server-side application adapter. A notification message is forwarded to a server stack. The notification message is sent from the server stack within the server to a client stack within the wireless client. The notification message is received on the client stack. The notification message is forwarded to a client-side application adapter. Authentication information is requested from an authentication manager module. Authentication information is checked for in a volatile memory within the wireless client. A request is sent from the client stack to the enterprise stack. Authentication information is authenticated on the enterprise server. A secure session is opened between the wireless client and the enterprise server. Data is transferred from the server stack to the client stack. Data is forwarded to the client-side application adapter. Data is forwarded to a client application. Data transferred between the wireless client and the enterprise server is encrypted. Data is transferred between the enterprise server and the wireless client through a wireless gateway. A time limit of the virtual memory is controlled by the authentication manager. The volatile memory is erased when the time limit is reached. The client-side application adapter is configured using a configuration file.

In general, in one aspect, the invention comprises a method for securely transferring wireless data from a wireless client to an enterprise server. The method comprises creating data on the wireless client. Data is forwarded to a client stack. Data is forward to a client-side application adapter. Authentication information is requested from an authentication manager module. Authentication information is checked for in a volatile memory within the wireless client. A request is sent from the client stack to the enterprise server. Authentication information is authenticated on the enterprise server. A secure session is opened between the wireless client and the enterprise server. Data is transferred from the client stack to a server stack. Data is forwarded to a server-side application adapter. Data is forwarded to a server application.

In general, in one aspect, the invention comprises a method for securely transferring wireless data from a wireless client to an enterprise server. The method comprises creating data on the wireless client. Data is forwarded to a client stack. Data is forwarded to a client-side application adapter. Authentication information is requested from an authentication manager module. Authentication information is checked for in a volatile memory within the wireless client. A request is sent from the client stack to the enterprise server. Authentication information is authenticated on the enterprise server. A secure session is opened between the wireless client and the enterprise server. Data is transferred from the client stack to a server stack. Data is forwarded to a server-side application adapter. Data is forwarded to a server application. Data transferred between the wireless client and the enterprise server is encrypted. Data is transferred between the enterprise server and the wireless client through a wireless gateway. A time limit of the volatile memory is controlled by the authentication manager. The volatile memory is erased when the time limit is reached. The client-side application adapter is configured using a configuration file.

In general, in one aspect, the invention comprises an apparatus for securely transferring wireless data from an enterprise server to a wireless client. The apparatus comprises means for receiving data on the enterprise server, means for triggering an event in a server-side application adapter, means for forwarding a notification message to the server stack, means for sending a notification message from the server stack within the enterprise server to the client stack within the wireless client, means for receiving the notification message on the client stack, means for forwarding the notification message to a client-side application adapter, means for requesting authentication information from an authentication manager module, means for checking for authentication information in a volatile memory within the wireless client, means for sending a request from the client stack to the enterprise server, means for authenticating authentication information on the enterprise server, means for opening a secure session between the wireless client and the enterprise server, means for transferring data from the server stack to the client stack, means for forwarding data to client-side application adapter, and means for forwarding data to a client application.

In general, in one aspect, the invention comprises an apparatus for securely transferring wireless data from a wireless client to an enterprise server. The apparatus comprises means for creating data on the wireless client, means for forwarding data to the client stack, means for forwarding data to a client-side application adapter, means for requesting authentication information from an authentication manager module, means for checking for authentication information in a volatile memory within the wireless client, means for sending a request from the client stack to the enterprise server, means for authenticating authentication information on the enterprise server, means for opening a secure session between the wireless client and the enterprise server, means for transferring data from the client stack to the server stack, means for forwarding data to the server-side application adapter, and means for forwarding data to a server application.

Other aspects and advantages of the invention will be apparent from the following description and the appended claims.

### BRIEF DESCRIPTION OF DRAWINGS

FIG. 1 illustrates a pull framework operating over a client/server model.

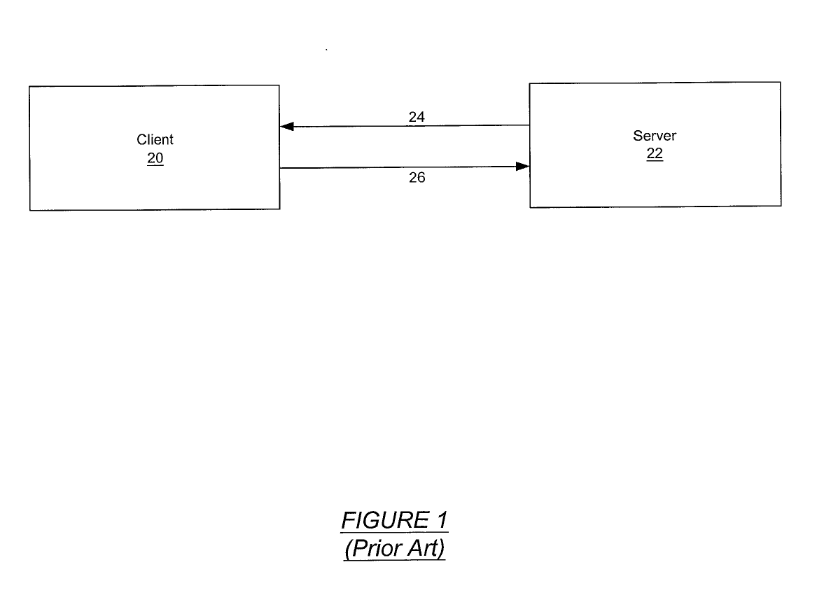

FIG. 2 illustrates a push framework operating over a client/server model.

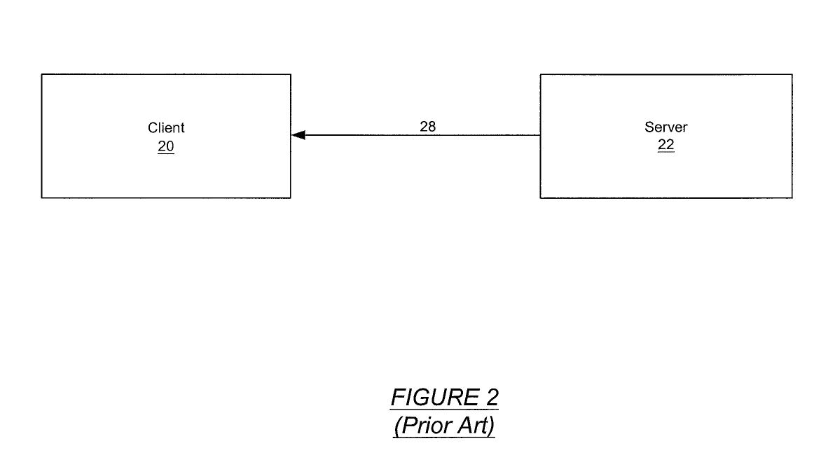

FIG. 3 illustrates a typical Wireless Application Protocol (WAP) push framework operating over a client/server model.

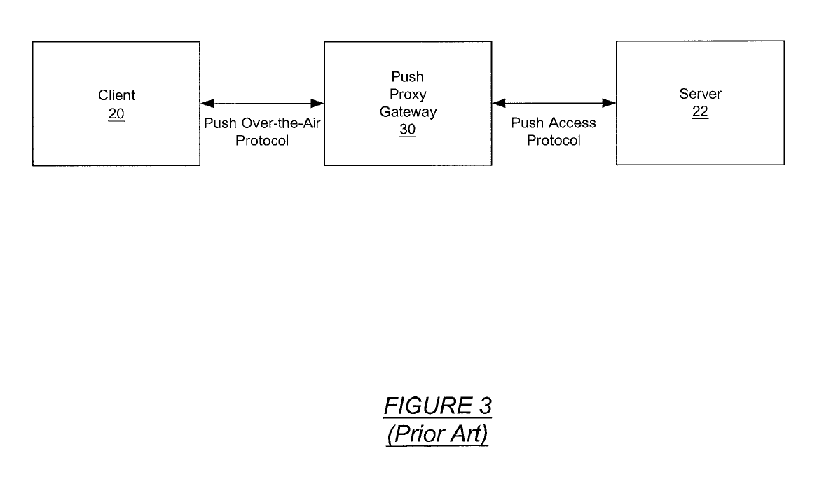

FIG. 4 illustrates a typical enterprise system operating using the WAP push framework.

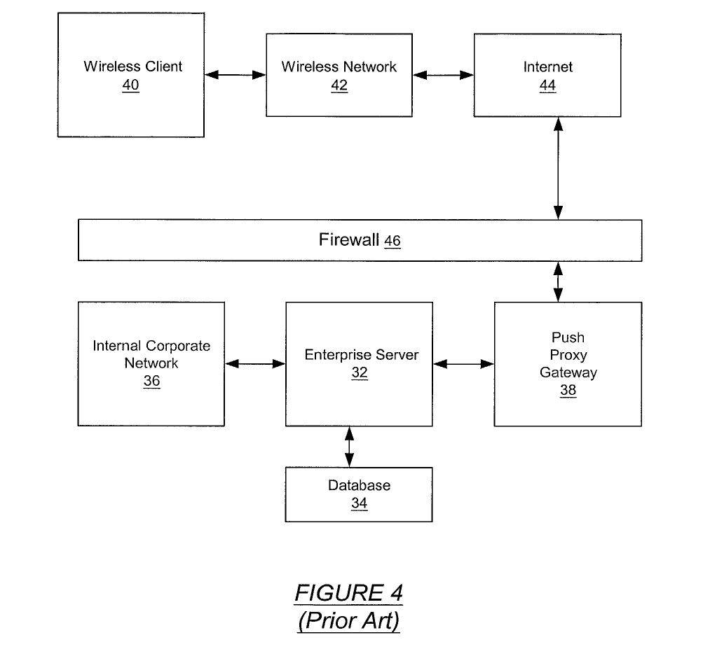

FIG. 5 illustrates an enterprise system, in accordance with one or more embodiments of the present invention.

FIG. 6 illustrates, in flowchart form, the typical steps involved in transferring secure data to a wireless device, in accordance with one or more embodiments of the present invention.

FIG. 7 illustrates, in flowchart form, the typical steps involved in transferring secure data from a wireless device, in accordance with one or more embodiments of the present invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to a method for securely transferring data to a wireless client from an enterprise server. Further, the present invention relates to a method for securely transferring data to a wireless client incorporating both a “push” framework and a “pull” framework. Further, the present invention relates to a method where a wireless client uses volatile memory to store sensitive authentication information. Further, the present invention relates to a method that allows a wireless device to open a secure session to transfer sensitive information from an enterprise server. Further, the present invention relates to a method that allows a wireless device to open a secure session to transfer sensitive information to an enterprise server.

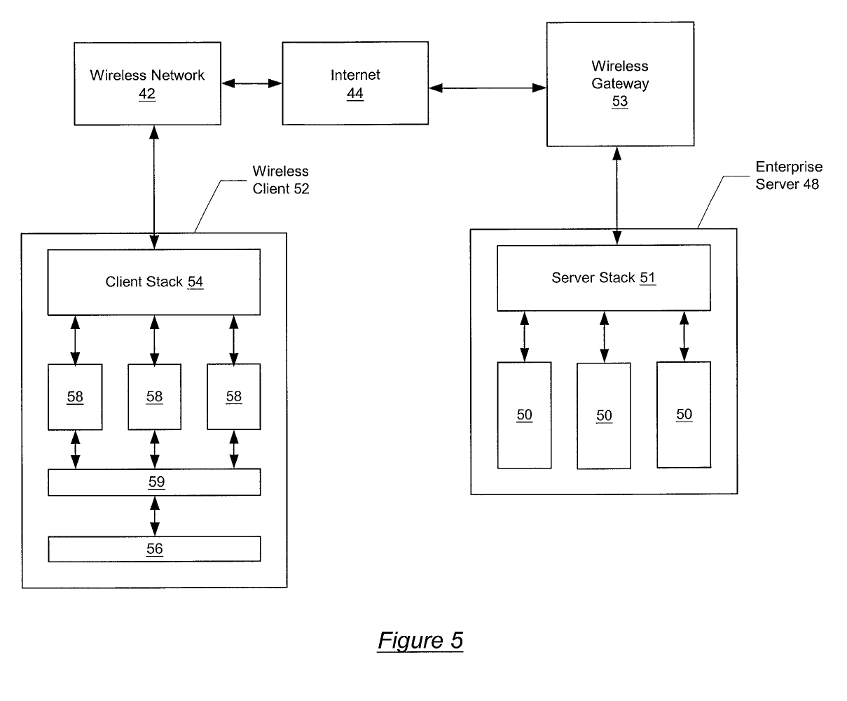

FIG. 5 illustrates a typical enterprise system in accordance with one or more embodiments of the present invention. An enterprise server (48) typically contains numerous server-side application adapters (50) connected to a server stack (51). The server-side application adapters (50) embed specific business logic into the enterprise server (48) that monitors particular applications, e.g., an e-mail server application, and responds to event triggers, e.g., new e-mail has arrived, by the application. The server-side application adapter (50) responds to the event triggers by forwarding corresponding notification messages via the server stack (51) to a wireless gateway (53). Within the enterprise system, the wireless gateway (53) acts as a wireless abstraction bearer, In other word, the wireless gateway (53) handles the technical disparities that exist between various wireless protocols, e.g., Mobitex packets, Short Message Service (SMS) packets, etc., allowing the present invention to work seamlessly with all types of wireless protocols.

The server stack (51) is WAP-compliant and provides optimized communication services for low bandwidth, packet-based wireless devices, e.g., wireless devices using Mobitex packets, SMS packets, etc. It is important to note that although the enterprise server (50) relies on the WAP-compliant server stack (51), the enterprise server is not a WAP-compliant server. The enterprise server (50) only relies on the WAP compliant server stack (51) to manage sessions, transaction, and datagram transport services. The wireless gateway (53) sends information via the Internet (44) and various wireless networks (42) to a wireless client (52).

The wireless client (52) contains a client stack (54), which is connected to numerous client-side application adapters (58), and an authentication manager module (59). The authentication manager module (59) is further connected to volatile memory (56). The client stack is WAP-compliant and provides optimized communication services for low bandwidth, packet-based wireless devices, e.g., wireless devices using Mobitex packets, Short Message Service (SMS) packets, etc. It is important to note that although the wireless client (52) relies on the WAP-compliant client stack (54), the wireless client is not a WAP browser. The wireless client (52) only relies on the WAP-compliant client stack (54) to manage sessions, transaction and datagram transport services.

The client-side application adapters (58), e.g., e-mail adapter, calendar adapter, directory adapter, etc., embed the specific business logic to request and receive information to and from the enterprise server (50), on behalf of the wireless client (52). Further, the client-side application adapters (58), typically, requires specific configuration to allow operation with corresponding adapter services e.g., e-mail adapter, etc. This configuration ensures that client application succeeds in interacting with the enterprise server (50). In one embodiment of the present invention, the client-side application adapters (58) are configured using a configuration file.

The authentication manager module (59) is responsible for directly managing the authentication information e.g., username and password, stored in the volatile memory (56). Further, the authentication manager module (59) typically serves as an interface between the volatile memory (56) and the client-side application adapters (58). In one embodiment of the present invention, the authentication manager (59) module is integrated with the client stack (54). Additionally, the wireless client (52) is typically required to support “push” and “pull” services as required by the present invention.

In one embodiment of the present invention, the volatile memory (58) is Random Access Memory (RAM). The volatile memory (58) holds sensitive authentication information such as a username and password. The incorporation of volatile memory (58) into the security scheme guarantees that sensitive information is only kept for a finite and determined period of time on the wireless client (52). This allows the user to be confident that sensitive information being sent to the wireless client (52) is secure.

Consider a scenario where a CEO, for a Paris-based corporation, has a business trip to New York, to meet potential foreign investors. The CEO constantly receives sensitive information via e-mail on her desktop computer that is connected to an internal corporate network. While she is away on her business trip, she still must be able to keep abreast of the latest information and potentially make decisions based on this information. With the present invention, the CEO (or an agent of the CEO) can load a server-side application adapter, an application stack on to the corporation's enterprise server, and a client stack and corresponding client-side application adapters onto her wireless device i.e., a Palm™ VIIx. Once the aforementioned components have been loaded, the corporation's IT department can assign the CEO authentication information, such as a username and a password, to logon onto the corporation's enterprise server. Thus, when the CEO is away from the office on her business trip, the present invention allows her to receive her e-mails, calendar updates, etc., without being concerned that sensitive information is exposed. Additionally, the present invention provides the CEO with current information, without requiring a persistent connection to the corporation's enterprise server or periodic connections to the corporation's server to check for new information. The aforementioned advantages are, in part, a result of combining a push framework with a pull framework to transfer data between the wireless device and the enterprise server.

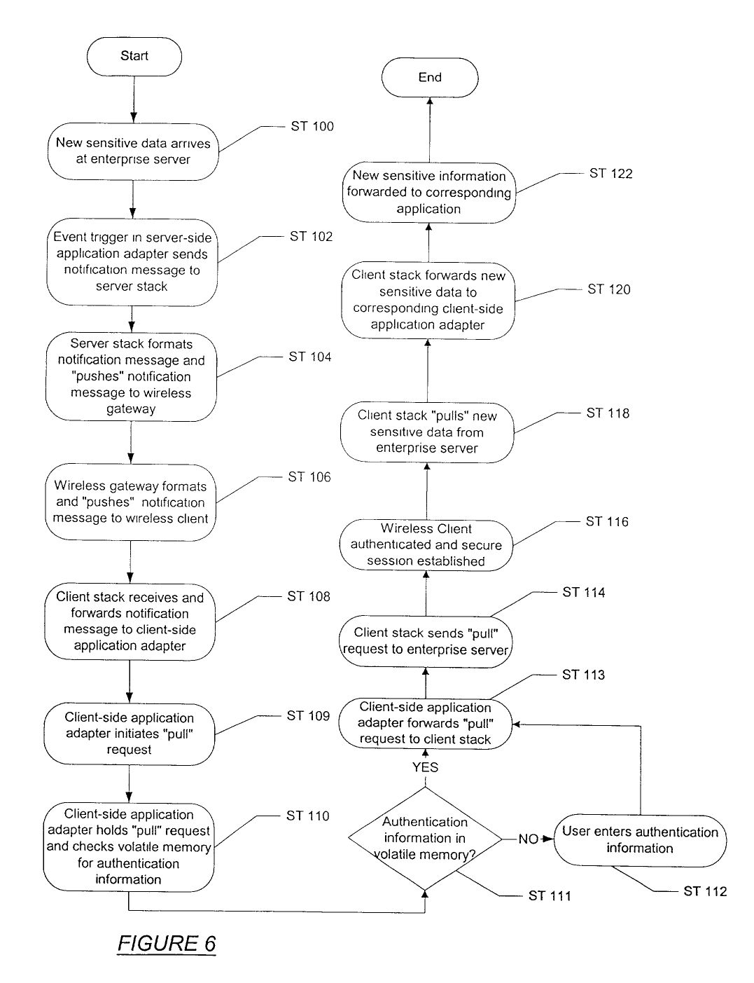

FIG. 6 illustrates, in flowchart form, the typical steps involved in securely transferring sensitive data to a wireless client from an enterprise server, in accordance with one or more embodiments of the present invention. New sensitive data, e.g., a new e-mail, arrives on the enterprise server (48) (Step 100). This new sensitive data prompts an event trigger within a corresponding server-side application adapter (50) to send a notification message, indicating that new data have arrived to a server stack (51) (Step 102). The notification message does not contain any sensitive data. The notification message, typically contains, data indicating a particular type of data, e.g., an e-mail, has been received. The server stack (51) forwards the notification message to the wireless gateway (53) (Step 104). The wireless gateway formats the notification message into a format recognized by the wireless device, e.g., SMS format, and “pushes” the notification message onto a wireless client (52) (Step 106). The client stack (54) on the wireless client (52) receives the notification message and forwards it to the corresponding client-side application adapter (58) (step 108). The client-side application adapter (58) subsequently initiates a “pull” request to download new sensitive data corresponding to the notification message (Step 109). The client-side application adapter holds the request and checks with the authentication manager module to get authentication information (e.g., username and password), and then forwards the “pull” request to the client stack (54) (Step 110).

If the authentication information is not in the volatile memory (56) (Step 111) the information must be re-entered, into the volatile memory by the user (Step 112). If the authentication information is in the volatile memory (Step 111), or once the authentication information has been re-entered into the volatile memory (56) (step 112), the client-side application adapter (58) forwards the “pull” request to the client stack (54) (Step 113). The client stack (54) proceeds to send the “pull” request to the enterprise server (52) via the wireless gateway (53) (Step 114). The “pull” request includes authentication information required for proper authentication and authorization of the transaction at the enterprise server (52). Once the wireless client (52) is authenticated, it establishes a secure session with the enterprise server (48) (Step 116). The client stack (52) via the wireless gateway (53), then “pulls” the new sensitive data to the client stack (54) (Step 118). The client stack (54) forwards the new sensitive data to a corresponding client-side application adapter (58) (Step 120). The new sensitive data is then forwarded to the corresponding client application where the new sensitive data is subsequently processed (Step 122).

Consider the scenario detailed above with the CEO still on her business trip to New York. Now suppose that she wishes to send an e-mail from her wireless device. The present invention allows the user to read, compose, and send her e-mail message from her wireless device in a secure fashion.

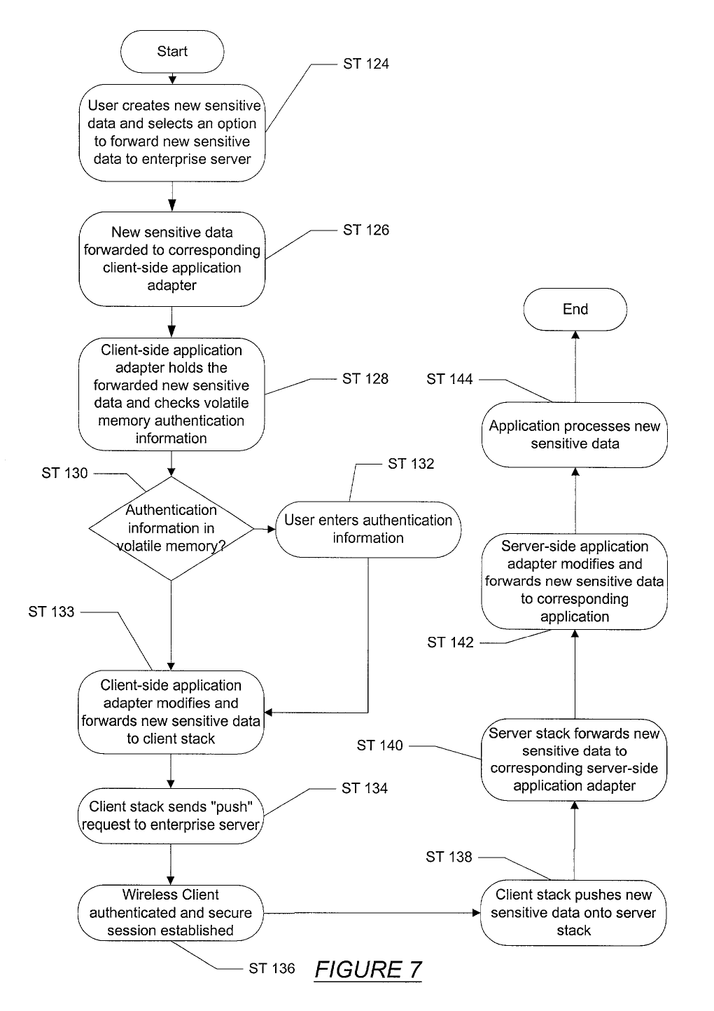

FIG. 7 illustrates, in flowchart form, the typical steps involved in the securely transferring data from a wireless client to an enterprise server, in accordance with one or more embodiments of the present invention. A user composes some new sensitive data on a wireless client (54) and clicks on an option that allows the user to send the new sensitive data to the enterprise server (48) (Step 124). The new sensitive data is forwarded to a corresponding client-side application adapter (58) (Step 126), which determines if there is authentication information in volatile memory (56) (Step 128).

If there is no authentication information in the volatile memory (54) (Step 130) the wireless client (52) prompts the user to re-enter the authentication information (Step 132). If there is authentication information in the volatile memory (Step 130), or once the user re-enters the authentication information (Step 132), the client-side application adapter modifies and forwards the new sensitive data to the client stack (54) (step 133). The client stack (54) proceeds to send a “push” request to upload the new sensitive data, to the enterprise server (48) via the wireless gateway (53) (Step 134). The “push” request includes authentication information required for proper authentication and authorization of the transaction at the enterprise server (48). Once the wireless client (52) has been authenticated, the enterprise server (48) establishes a secure connection with the wireless client (52) (Step 136). Once the secure connection has been established, the client stack (54) converts the new sensitive data to the correct format for wireless transmission, e.g., SMS format, and pushes the new sensitive data to server stack (51) via the wireless gateway (53) (Step 138). The server stack (51) forwards the new sensitive data to a corresponding server-side application adapter (50), e.g., if the new sensitive data is an e-mail then the new sensitive data is forwarded to the server-side e-mail adapter (Step 140). The server-side application adapter (50) modifies the new sensitive data into a format recognized by the application and forwards the new sensitive information to a corresponding application (Step 142). The application subsequently processes the new sensitive information i.e., if the new sensitive information is an email the application sends the e-mail (Step 144).

In one or more embodiments of the present invention, the username is the wireless address assigned to the user's device. Further, the user does not need to enter the username, as it is stored in a persistent portion of the memory i.e., the username is not erased when the password expires.

In one or more embodiments of the present invention, all data transferred between a wireless client and an enterprise server via a wireless gateway is encrypted. Further, in one embodiment of the invention, data is encrypted using a wireless transport level security (WTLS) layer protocol that is embedded within a wireless client stack. In another embodiment of the present invention, the data is encrypted using a Public Key Infrastructure (PKI) protocol that is embedded in a layer between the client stack and client-side application adapters. In another embodiment of the present invention, data is encrypted using the both aforementioned encryption techniques.

In one or more embodiments of the present invention, sensitive authentication information, e.g., a user password, stored in volatile memory on a wireless client expires after a pre-determined time e.g., after 30 minutes. Once this time limit has expired, the authentication information is erased from the volatile memory. Without the authentication information, a wireless client may still receive notification that new sensitive data has arrived and is waiting to be downloaded. However, because the authentication information has been erased, the wireless client is not able to download the information until the authentication information is re-entered by the client.

Further, in one or more embodiments of the present invention, the authentication manager module controls the time limit whereby the user may decrease the time limit allowed to keep the sensitive information storage in the volatile memory, within a range specified by the corporation. The time limit is not allowed to increase beyond the limit defined by the corporation. Once the time limit is reached the authentication manager module erases the volatile memory. The corporation has the authority to change the time limit to any value. The corporation may also remotely set the time limit to “infinity”. This scenario occurs whenever the user does not require wireless access to sensitive information.

Advantages of the present may include one or more of the following. A wireless client is allowed to transparently receive new sensitive information from an enterprise server in a secure manner. More specifically, by using a push framework to send a notification message and a pull framework to retrieve the sensitive information, the present invention ensures that sensitive information is securely transferred to the wireless client. The user is allowed to load information, in a transparent manner, to the enterprise server in a secure manner. Sensitive information is stored on volatile memory located on the wireless device allowing the security scheme to maintain system integrity. The user is allowed to have current information displayed on their wireless device without having a persistent connection to the enterprise server or periodically establishing a session with the enterprise server to check for new information. Those skilled in the art can appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for secure transfer of wireless data, comprising:
a wireless client;
an enterprise server;
a server stack providing communication services between the enterprise server and the wireless client, wherein the server stack is located on the enterprise server;
a client stack providing communication services between the enterprise server and the wireless client, wherein the client stack is located on the wireless client;
a server-side application adapter providing an interface between the server stack and a server application located on the enterprise server;
a client-side application adapter providing an interface between the client stack and a client application located on the wireless client;
a volatile memory for storing authentication information on the wireless client; and
an authentication manager module managing authentication information in the volatile memory and transferring authentication information to the client-side application adapter.

2. The system of claim 1, further comprising:
a wireless gateway providing an interface between the enterprise server and the wireless client.

3. The system of claim 1, wherein data transferred between the wireless client and the enterprise server is encrypted.

4. The system of claim 3, wherein data is encrypted using Wireless Transport Layer Security protocol embedded within the client stack.

5. The system of claim 3, wherein data is encrypted using a Public Key Infrastructure mechanism embedded between the client stack and the client-side application adapter.

6. The system of claim 3, wherein data is encrypted using Wireless Transport Layer Security protocol embedded within the client stack and data is encrypted using a Public Key Infrastructure mechanism embedded between the client stack and the client-side application adapter.

7. The system of claim 1, wherein the server stack is Wireless Application Protocol compliant.

8. The system of claim 1, wherein the client stack is Wireless Application Protocol compliant.

9. The system of claim 1, wherein the volatile memory is Random Access Memory.

10. The system of claim 1, wherein the client-side application adapter is configured using a configuration file.

11. The system of claim 1, wherein the authentication manager module is integrated with the client stack.

12. The system of claim 1, wherein the authentication manager module controls a time limit of volatile memory.

13. The system of claim 12, wherein the time limit is configurable from within the authentication manager module.

14. The system of claim 12, wherein the volatile memory is erased when the time limit is reached.

15. The system of claim 12, wherein the time limit is remotely configurable.

16. A system to securely transfer wireless data, comprising:
a wireless client;
an enterprise server;
a server stack providing communication services between the enterprise server and the wireless client, wherein the server stack is located on the enterprise server;
a client stack providing communication services between the enterprise server and the wireless client, wherein the client stack is located on the wireless client;
a server-side application adapter providing an interface between the server stack and a server application located on the enterprise server;
a client-side application adapter providing an interface between the client stack and a client application located on the wireless client;
a volatile memory for storing authentication information on the wireless client;
an authentication manager module managing authentication information in the volatile memory and transferring authentication information to the client-side application adapter; and
a wireless gateway providing an interface between the enterprise server and the wireless client.

17. An enterprise server for securely transferring wireless data, comprising:
a server stack providing communication services between the enterprise server and a wireless client, wherein the server stack is located on the enterprise server; and
a server-side application adapter providing an interface between the server stack and a server application located on the enterprise server.

18. The enterprise server of claim 17, wherein the server stack is Wireless Application Protocol compliant.

19. The enterprise server of claim 17, wherein the server-side application adapter embeds specific business logic into the enterprise server and monitors server applications.

20. A wireless client for securely transferring wireless data, comprising:
a client stack providing communication services between an enterprise server and the wireless client, wherein the client stack is located on the wireless client;
a client-side application adapter providing an interface between the client stack and a client application located on the wireless client;
a volatile memory for storing authentication information on the wireless client; and
an authentication manager module managing authentication information in the volatile memory and transferring authentication information to the client-side application adapter.

21. The wireless client of claim 20, wherein the client stack is Wireless Application Protocol compliant.

22. The wireless client of claim 20, wherein the volatile memory is Random Access Memory.

23. The wireless client of claim 20, wherein the authentication manager module integrated with the client stack.

24. The wireless client of claim 20, wherein the authentication manager module controls a time limit of volatile memory.

25. The wireless client of claim 24, wherein the time limit is configurable from within the authentication manager module.

26. The wireless client of claim 24, wherein the volatile memory is erased when the time limit is reached.

27. The wireless client of claim 24, wherein the time limit is remotely configurable.

28. The wireless client of claim 20, wherein the client-side application adapter embeds specific business logic into the wireless client and monitors client applications.

29. The wireless client of claim 20, wherein the client-side application adapter is configured using a configuration file.

30. A method for secure transfer of wireless data from an enterprise server to a wireless client, comprising:
receiving data on the enterprise server;
triggering an event in a server-side application adapter;
forwarding a notification message to a server stack;
sending the notification message from the server stack within the enterprise server to a client stack within the wireless client;
receiving the notification message on the client stack;
forwarding the notification message to a client-side application adapter;
requesting authentication information from an authentication manager module;
checking for authentication information in a volatile memory within the wireless client;
sending a request from the client stack to the enterprise server;
authenticating authentication information on the enterprise server;
opening a secure session between the wireless client and the enterprise server;
transferring data from the server stack to the client stack;
forwarding data to the client-side application adapter; and
forwarding data to a client application.

31. The method of claim 30, further comprising:
encrypting data transferred between the wireless client and the enterprise server.

32. The method of claim 31, wherein data is encrypted using Wireless Transport Layer Security protocol embedded within the client stack.

33. The method of claim 31, wherein data is encrypted using a Public Key Infrastructure mechanism embedded between the client stack and the client-side application adapter.

34. The method of claim 31, wherein data is encrypted using Wireless Transport Layer Security protocol embedded within the client stack and data is encrypted using a Public Key Infrastructure mechanism embedded between the client stack and the client-side application adapter.

35. The method of claim 30, further comprising:
transferring data between the enterprise server and the wireless client through a wireless gateway, wherein the wireless gateway provides an interface between the enterprise server and the wireless client

36. The method of claim 30, further comprising:
controlling a time limit of the volatile memory using the authentication manager module.

37. The method of claim 36, wherein the time limit is configurable from within the authentication manager module.

38. The method of claim 36, further comprising:
erasing the volatile memory when the time limit is reached.

39. The method of claim 36, wherein the time limit is remotely configurable from within the authentication manager module.

40. The method of claim 30, further comprising:
configuring the client-side application adapter using a configuration file.

41. The method of claim 30, wherein the authentication information comprises a username and a password.

42. The method of claim 30, wherein the authentication information comprises a wireless client address and a password.

43. The method of claim 30, wherein the volatile memory is Random Access Memory.

44. A method for securely transferring wireless data from an enterprise server to a wireless client, comprising:
receiving data on the enterprise server;
triggering an event in a server-side application adapter;
forwarding a notification message to the server stack;
sending the notification message from the server stack within the enterprise server to the client stack within the wireless client;
receiving the notification message on the client stack;
forwarding the notification message to a client-side application adapter;
requesting authentication information from an authentication manager module;
checking for authentication information in a virtual memory within the wireless client;
sending a request from the client stack to the enterprise server;
authenticating authentication information on the enterprise server;
opening a secure session between the wireless client and the enterprise server;
transferring data from the server stack to the client stack;
forwarding data to client-side application adapter;
forwarding data to a client application;
encrypting data transferred between the wireless client and the enterprise server;
transferring data between the enterprise server and the wireless client through a wireless gateway, wherein the wireless gateway provides an interface between the enterprise server and the wireless client;
controlling a time limit of the virtual memory using the authentication manager module;
erasing the volatile memory when the time limit is reached; and
configuring the client-side application adapter using a configuration file.

45. A method for securely transferring wireless data from a wireless client to an enterprise server, comprising:
creating data on the wireless client;
forwarding data to a client stack;
forwarding data to a client-side application adapter;
requesting authentication information from an authentication manager module;
checking for authentication information in a volatile memory within the wireless client;
sending a request from the client stack to the enterprise server;
authenticating authentication information on the enterprise server;
opening a secure session between the wireless client and the enterprise server;
transferring data from the client stack to a server stack;
forwarding data to a server-side application adapter; and
forwarding data to a server application.

46. The method of claim 45, further comprising:
encrypting data transferred between the wireless client and the enterprise server.

47. The method of claim 46, wherein data is encrypted using Wireless Transport Layer Security protocol embedded within the client stack.

48. The method of claim 46, wherein data is encrypted using a Public Key Infrastructure mechanism embedded between the client stack and the client-side application adapter.

49. The method of claim 45, wherein data is encrypted using Wireless Transport Layer Security protocol embedded within the client stack and data is encrypted using a Public Key Infrastructure mechanism embedded between the client stack and the client-side application adapter.

50. The method of claim 45, further comprising:
transferring data between the enterprise server and the wireless client through a wireless gateway, wherein the wireless gateway provides an interface between the enterprise server and the wireless client.

51. The method of claim 45, further comprising:
controlling a time limit of the volatile memory using the authentication manager module.

52. The method of claim 51, wherein the time limit is configurable from within the authentication manager module.

53. The method of claim 51, further comprising:
erasing the volatile memory when the time limit is reached.

54. The method of claim 51, wherein the time limit is remotely configurable from within the authentication manager module.

55. The method of claim 45, further comprising:
configuring the client-side application adapter using a configuration file.

56. The method of claim 45, wherein authentication information comprises a username and a password.

57. The method of claim 45, wherein authentication information comprises a wireless client address and a password.

58. The method of claim 45, wherein the volatile memory is Random Access Memory.

59. A method for securely transferring wireless data from a wireless client to an enterprise server comprising:
creating data on the wireless client;
forwarding data to the client stack;
forwarding data to a client-side application adapter;
requesting authentication information from an authentication manager module;
checking for authentication information in a volatile memory within the wireless client;
sending a request from the client stack to the enterprise server;
authenticating authentication information on the enterprise server;
opening a secure session between the wireless client and the enterprise server;
transferring data from the client stack to the server stack;
forwarding data to the server-side application adapter;
forwarding data to a server application;
encrypting data transferred between the wireless client and the enterprise server;
transferring data between the enterprise server and the wireless client through a wireless gateway, wherein the wireless gateway provides an interface between the enterprise server and the wireless client;
controlling a time limit of the volatile memory using the authentication manager module;
erasing the volatile memory when the time limit is reached; and
configuring the client-side application adapter using a configuration file.

60. An apparatus for securely transferring wireless data from an enterprise server to a wireless client, comprising:
means for receiving data on the enterprise server;
means for triggering an event in a server-side application adapter;
means for forwarding a notification message to the server stack;
means for sending a notification message from the server stack within the enterprise server to the client stack within the wireless client;
means for receiving the notification message on the client stack;
means for forwarding the notification message to a client-side application adapter;
means for requesting authentication information from an authentication manager module;
means for checking for authentication information in a volatile memory within the wireless client;
means for sending a request from the client stack to the enterprise server;
means for authenticating authentication information on the enterprise server;
means for opening a secure session between the wireless client and the enterprise server;
means for transferring data from the server stack to the client stack;
means for forwarding data to client-side application adapter; and
means for forwarding data to a client application.

61. An apparatus for securely transferring wireless data from a wireless client to an enterprise server, comprising:
means for creating data on the wireless client;
means for forwarding data to the client stack;
means for forwarding data to a client-side application adapter;
means for requesting authentication information from an authentication manager module;
means for checking for authentication information in a volatile memory within the wireless client;
means for sending a request from the client stack to the enterprise server;
means for authenticating authentication information on the enterprise server;
means for opening a secure session between the wireless client and the enterprise server;
means for transferring data from the client stack to the server stack;
means for forwarding data to the server-side application adapter; and
means for forwarding data to a server application.
